(19) United States
(12) Patent Application Publication
(10) Pub. No.: US 2016/0275531 A1
(43) Pub. Date: Sep. 22, 2016

(54) AURA COLOR COMPANION GENERATOR

(71) Applicant: JJMAC ENTERPRISES II, LLC, Port Saint Lucie, FL (US)

(72) Inventors: Kurt Martyn, Haslett, MI (US); Jon McKenzie, Port Saint Lucie, FL (US)

(73) Assignee: JJMAC ENTERPRISES II, LLC, Port Saint Lucie, FL (US)

(21) Appl. No.: 15/072,253

(22) Filed: Mar. 16, 2016

Related U.S. Application Data
(60) Provisional application No. 62/133,587, filed on Mar. 16, 2015.

(51) Int. Cl. G06Q 30/02; G06Q 50/00

(52) U.S. Cl. CPC G06Q 30/0203; G06Q 50/01

(57) ABSTRACT

An aura color companion system configured to function as a relationship prediction system to create matches between individuals to form relationships is disclosed. The relationship prediction system may use aura colors to determine the likelihood of two individuals forming a successful relationship. The relationship prediction system may pose numerous questions to a user of the system to determine which aura color best corresponds with the user. The system may generate a list of individuals who match with the user based upon the aura color matching scheme. The system may also be configured to provide more accurate match search results based on location, age and other factors for a list of potential matching people to the user. The user may pursue contacting one or more of the people listed in the list of potential matching people at the user's sole discretion.

### CROSS-REFERENCE TO RELATED APPLICATION

This application claims the benefit of U.S. Provisional Patent Application No. 62/133,587, filed Mar. 16, 2015, the entirety of which is incorporated herein.

### FIELD OF THE INVENTION

This invention is directed generally to relationship prediction systems, and more particularly to relationship prediction systems configured to create matches between individuals to form relationships.

### BACKGROUND

There exist numerous matching making services and online relationship services configured to generate matches for users of the systems. While these systems have achieved varying levels of success, there remains a need for a more effective system for developing personal, romantic relationships between people.

### SUMMARY

An aura color companion system configured to function as a relationship prediction system to create matches between individuals to form relationships is disclosed. The relationship prediction system may use aura colors to determine the likelihood of two individuals forming a successful relationship. The relationship prediction system may pose numerous questions to a user of the system to determine which aura color best corresponds with the user. The system may generate a list of individuals who match with the user based upon the aura color matching scheme. The system may also be configured to provide more accurate match search results based on location, age and other factors for a list of potential matching people to the user. The user may pursue contacting one or more of the people listed in the list of potential matching people at the user's sole discretion.

In at least one embodiment, the aura color companion system may include a memory that stores instructions and a processor that executes the instructions to perform operations. The operations may include receiving answers from a person to questions pertaining to that person to determine aura color associations with that person. The operations may also include generating an aura color for the person by adding answer weights corresponding to each yes answer by that person for each aura color, ranking each aura color for that person with the largest number associated with an aura color ranking first and a smallest number associated with an aura color ranking last and identifying the aura color ranking first as a first level aura color for that person. The operations may include generating at least one match corresponding with the first level aura color for that person.

The operations may also include generating at least one match corresponding with the first level aura color for that person further comprises generating a list of matches corresponding with the first level aura color. The operation of generating at least one match corresponding with the first level aura color for that person comprises generating a list of all matches according to the following aura color matching scheme: yellow with yellow, orange with orange, blue with violet, red with green, violet with blue and green with red.

The operations may include identifying a second level aura color match via identifying an aura color ranking second as a second level aura color for that person and generating at least one match, if any exist in the system, corresponding with the first level aura color for that person and corresponding with the second level aura color. The operations may also include identifying a third level aura color match via identifying an aura color ranking third as a third level aura color for that person and generating at least one match, if any exist in the system, corresponding with the first level aura color for that person, corresponding with the second level aura color and corresponding with the third level aura color. The operations may include the operation of identifying a fourth level aura color match via identifying an aura color ranking fourth as a fourth level aura color for that person and generating at least one match, if any exist in the system, corresponding with the first level aura color for that person, corresponding with the second level aura color, corresponding with the third level aura color and corresponding with the fourth level aura color.

The operation of receiving answers from a person to questions pertaining to that person to determine aura color associations with that person may include receiving at least one answer to a plurality of questions provided to the person, whereby the questions include a plurality of questions associated with each aura color within the system. The operation of receiving at least one answer to a plurality of questions provided to the person may include receiving at least one answer to a plurality of questions provided to the person, whereby the questions include a plurality of questions associated with each aura color within the system including, yellow, orange, blue, violet, red and green. The operation of receiving answers from a person to questions pertaining to that person to determine aura color associations with that person may include receiving answers from the person to questions associated with each aura color have a corresponding answer weight signifying relative strength of the question and answer to a determination of an aura color with the person answering the questions, and wherein at least one of the questions for an aura color has a greater answer weight than other questions. The operation of receiving answers from a person to questions pertaining to that person to determine aura color associations with that person may include receiving answers from the person to questions associated with each aura color have a corresponding answer weight signifying relative strength of the question and answer to a determination of an aura color with the person answering the questions, and wherein each answer weight associated with questions for at least one aura color are different by at least 10 percent from other answer weights for questions associated with that same aura color. The operation of receiving answers from a person to questions pertaining to that person to determine aura color associations with that person may include receiving answers from the person to questions associated with each aura color have a corresponding answer weight signifying relative strength of the question and answer to a determination of an aura color with the person answering the questions, and wherein an answer weight associated with a most important question for at least one aura color is at least 90 percent greater than answer weight for a least important question associated with that same aura color.

The operations may include searching the at least one match corresponding with the first level aura color for that person based upon at least one search criteria. The operation of searching the at least one match corresponding with the first level aura color for that person based upon at least one search criteria may include searching the at least one match corresponding with the first level aura color for that person based upon at least one search criteria being at least one personal attribute. The operations may include storing aura color match levels for each person having an account with the system. The operation of storing aura color match levels for each person having an account with the system may include storing at least one personal attribute corresponding with each person and submitted by each person to the system.

The system may be implemented via a method of assisting formation of personal relationships including receiving answers from a person to questions pertaining to that person to determine aura color associations with that person, generating an aura color for the person by adding answer weights corresponding to each yes answer by that person for each aura color, ranking each aura color for that person with the largest number associated with an aura color ranking first and a smallest number associated with an aura color ranking last and identifying the aura color ranking first as a first level aura color for that person, and generating at least one match corresponding with the first level aura color for that person. The method may also include identifying second level aura color matches, third level aura color matches or fourth level aura color matches, or any combination thereof. The method may include identifying a second level aura color match via identifying an aura color ranking second as a second level aura color for that person and generating at least one match, if any exist in the system, corresponding with the first level aura color for that person and corresponding with the second level aura color. The method may include identifying a third level aura color match via identifying an aura color ranking third as a third level aura color for that person and generating at least one match, if any exist in the system, corresponding with the first level aura color for that person, corresponding with the second level aura color and corresponding with the third level aura color. The method may include identifying a fourth level aura color match via identifying an aura color ranking fourth as a fourth level aura color for that person and generating at least one match, if any exist in the system, corresponding with the first level aura color for that person, corresponding with the second level aura color, corresponding with the third level aura color and corresponding with the fourth level aura color.

The method step of receiving answers from a person to questions pertaining to that person to determine aura color associations with that person may also include receiving at least one answer to a plurality of questions provided to the person, whereby the questions include a plurality of questions associated with each aura color within the system and further comprising receiving answers from the person to questions associated with each aura color have a corresponding answer weight signifying relative strength of the question and answer to a determination of an aura color with the person answering the questions, and wherein at least one of the questions for an aura color has a greater answer weight than other questions. The method may include searching the at least one match corresponding with the first level aura color for that person based upon at least one search criteria being at least one personal attribute.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a schematic diagram of the aura color companion system.

FIG. 2 is an example of an aura compatibility chart.

FIG. 3 is an exemplary display of Aura test results for a user of the aura color companion system.

FIG. 4 is a flow chart of an aura test compose of six groups of 10 questions, one set for each of the six aura colors shown, including, red, blue, violet, green, orange and yellow, and addition of the answer weights for each answer and identification of the highest answer weight and corresponding aura color, thereby identifying the user's aura color.

FIG. 5 is a screenshot of an example of a home page of the aura color companion system.

FIG. 6 is a screenshot of an example of an information page of the aura color companion system.

FIG. 7 is a screenshot of an example of another information page of the aura color companion system.

FIG. 8 is a screenshot of an example of questions posed to a user during an aura color test of the aura color companion system to determine an aura color for the user.

FIG. 9 is a screenshot of an example of an aura test result for a user showing the user's first level, or predominant, aura color and also the aura color most compatible with the user, which in this example is a red aura color associated with the user and a green aura color as the compatible aura color for the user.

FIG. 10 is a screenshot of an example of matching users of the aura color companion system generated upon completion of the aura test by the user.

FIG. 11 is a schematic diagram of a communications network system with which the aura color companion system may operate.

FIG. 12 is an illustrative embodiment of a general computer system with which the aura color companion system may operate.

FIG. 13 is a schematic diagram of a method of operation of the aura color companion system.

### DETAILED DESCRIPTION OF THE INVENTION

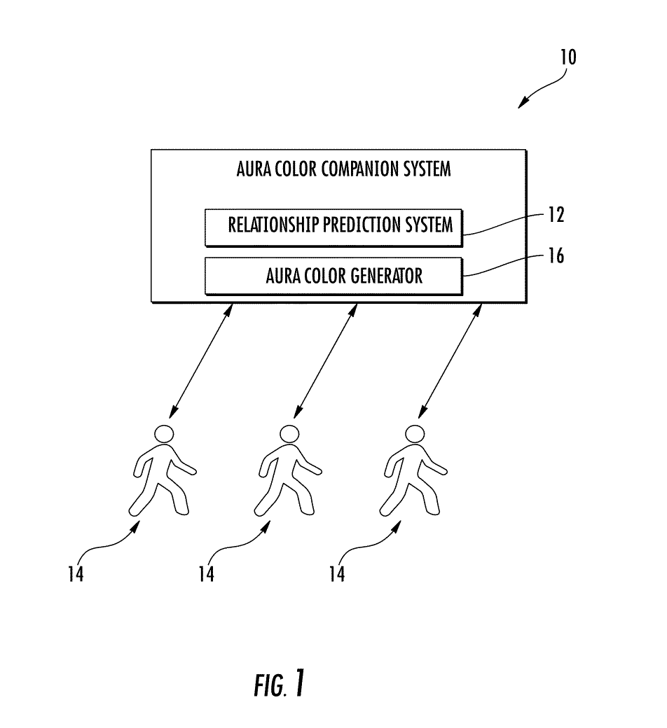

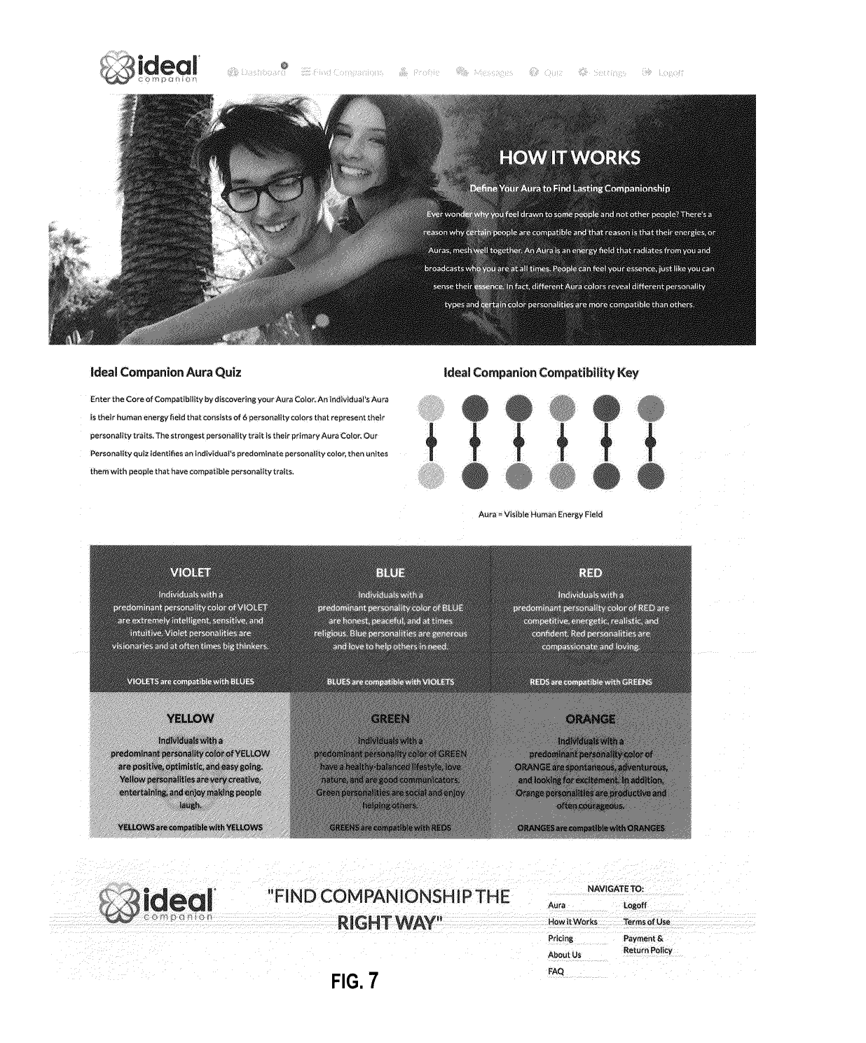

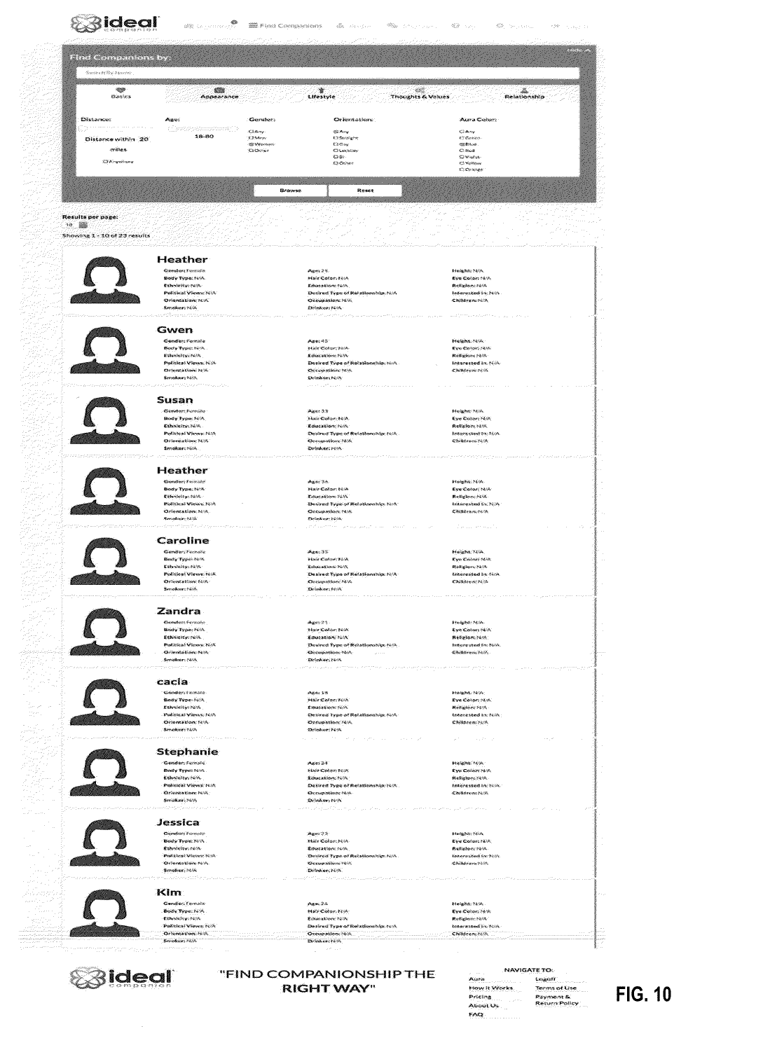

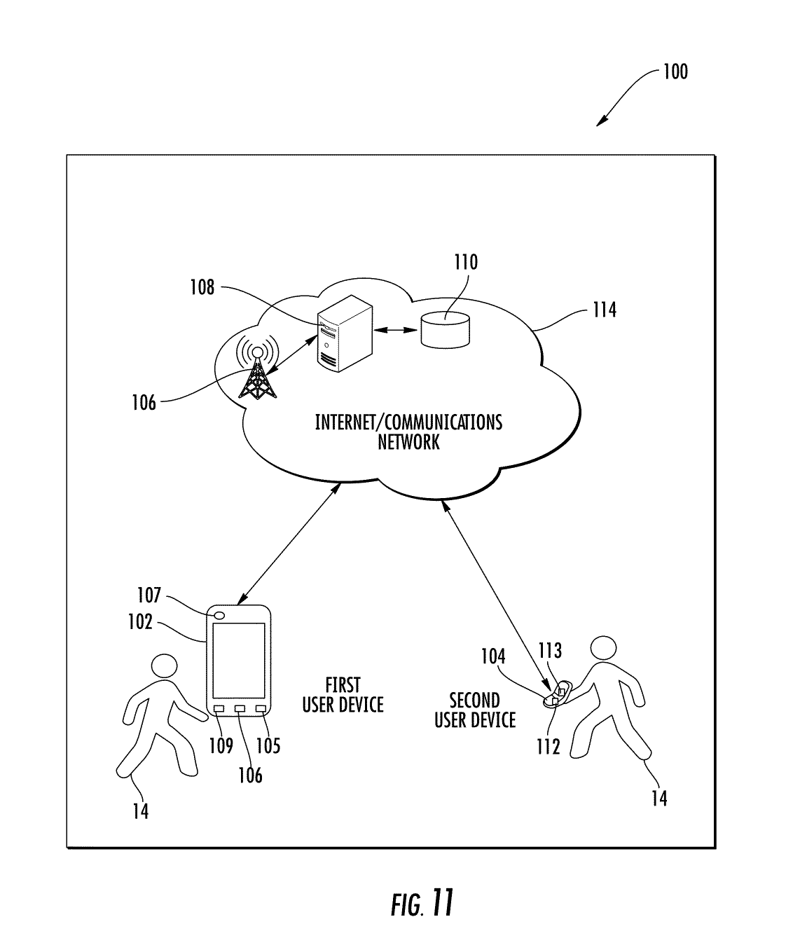

As shown in FIGS. 1-13, an aura color companion system 10 configured to function as a relationship prediction system 12 to create matches between individuals to form relationships is disclosed. The relationship prediction system 12 may use aura colors 18 to determine the likelihood of two individuals forming a successful relationship. The relationship prediction system 12 may pose numerous questions to a user 14 of the system to determine which aura color 18 best corresponds with the user 14. The system 12 may generate a list of individuals who match with the user 14 based upon the aura color matching scheme. The system 12 may also be configured to provide more accurate match search results based on location, age and other factors for a list of potential matching people to the user 14. The user 14 may pursue contacting one or more of the people listed in the list of potential matching people at the user's sole discretion.

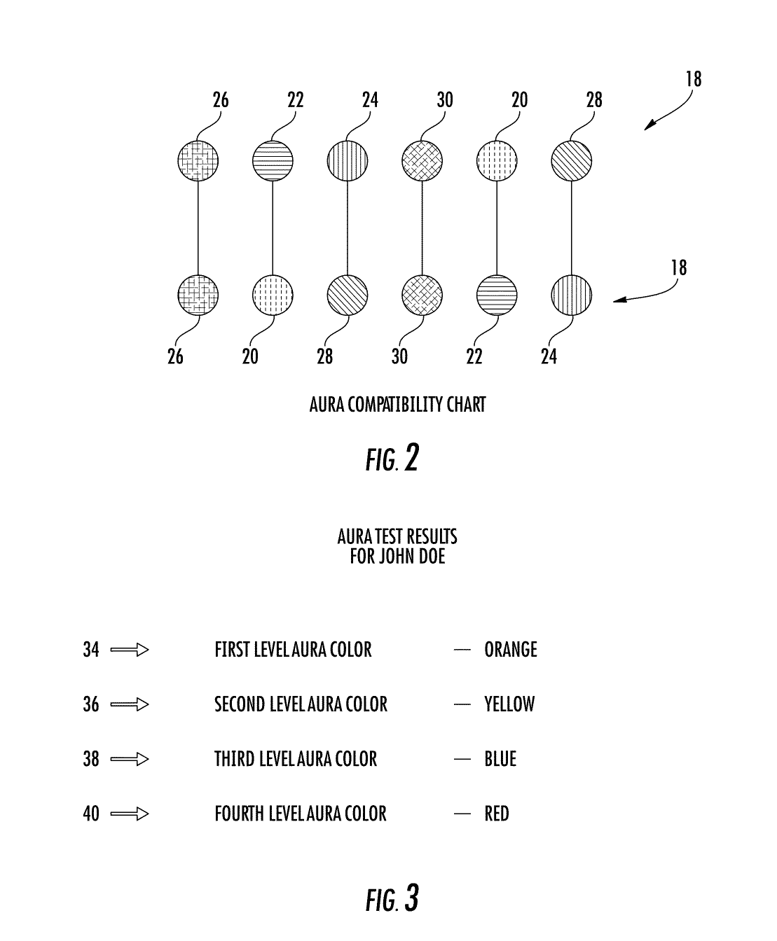

In at least one embodiment, the aura color companion system 10 may associate an aura color 18 with an individual 14. The generation of an aura color 18 with an individual 14 is discussed in much greater depth below. The aura color companion system 10 may then generate potential matches with that individual 14 based upon the compatibility of the aura color 18 assigned to each person 14. In at least one embodiment, there may be a plurality of personality traits that correspond to aura colors 18. In at least one embodiment, there are 45 different predominate personality traits that correspond with 45 aura colors 18. In at least one embodiment of the system 10, these 45 predominate personality traits have been combined to yield six predominate personality colors associated with people and include, red, yellow, green, blue, orange and violet, as shown in FIGS. 2, 4 5 and 7. In other embodiments, the aura color companion system 10 may use more than six aura colors. In at least one embodiment of the system 10, a violet aura color 20 may be associated with a person who is extremely intelligent, sensitive, and intuitive. A person associated with a violet aura color 20 is often a visionary and a big thinker. A blue aura color 22 may be associated with a person who is honest, peaceful, and at times, religious. A person associated with a blue aura color 22 is often a generous and loves to help others in need. A red aura color 24 may be associated with a person who is competitive, energetic, realistic and confident. A person associated with a red aura color 24 is often compassionate and loving. A yellow aura color 26 may be associated with a person who is positive, optimistic and easy going. A person associated with a yellow aura color 26 is often very creative, entertaining and enjoys making people laugh. A green aura color 28 may be associated with a person who has a healthy, balanced lifestyle, loves nature and is a good communicator. A person associated with a green aura color 28 is often social and enjoys helping others. An orange aura color 30 may be associated with a person who is spontaneous, adventurous, and looking for excitement. A person associated with an orange aura color 30 is often productive and courageous. Each aura color 18 has different levels of compatibility with the other aura colors 18, as denoted in FIGS. 2 and 4. For example, as shown in FIGS. 2 and 4, the listed aura colors 18 are compatible as follows:

| | | |
|---|---|---|
| Violet | is compatible with | Blue |
| Blue | is compatible with | Violet |
| Red | is compatible with | Green |
| Green | is compatible with | Red |
| Yellow | is compatible with | Yellow |
| Orange | is compatible with | Orange |

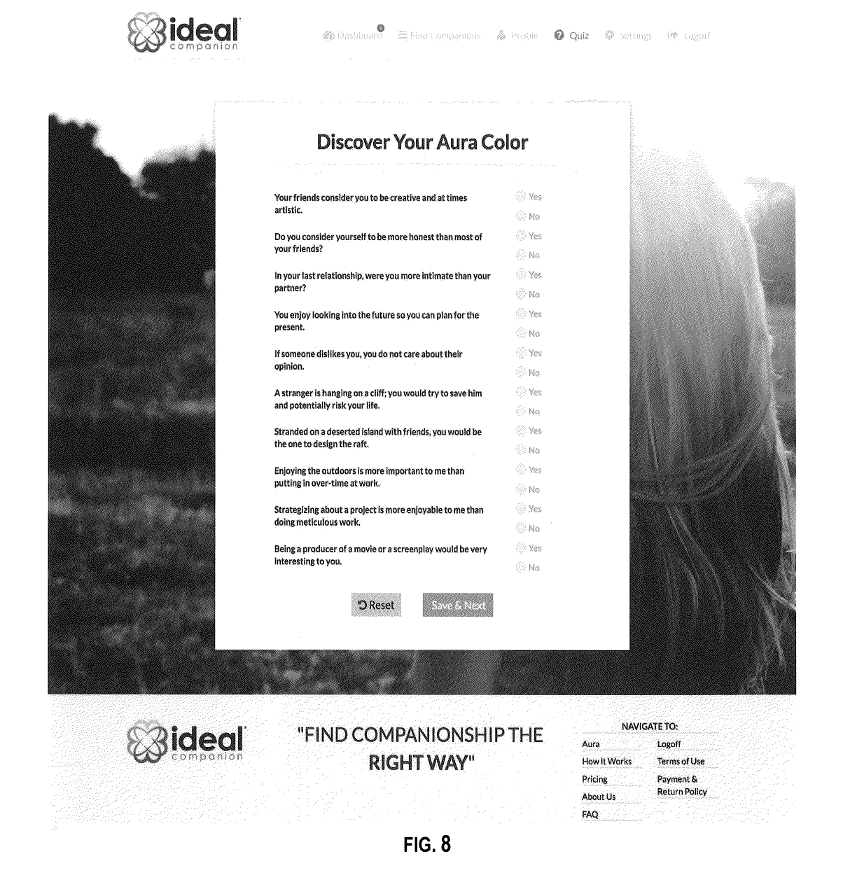

The aura color companion system 10 may first determine a user's aura color 18 through us of an aura color generator 16. The aura color generator 16 may perform an assessment of a user's personality via posing a number of questions to the user to identify the user's predominate personality aura color 18, otherwise known as a personality trait. One or more of the aura colors 18 may have a plurality of questions associated with each aura color 18. The aura color generator 16 may use an answer weight scale to analyze the answers provided by the user to numerous questions. In at least one embodiment, the aura color generator 16 may include presenting a plurality of questions, as shown in FIGS. 4 and 8, to a user to determine which of the aura colors 18 most closely aligns with the user's personality. In at least one embodiment, the aura color generator may present a 60 question test, where a different set of ten questions corresponds with each of the six aura colors 18 identified above. For example, the aura red color 24 may be allocated 10 questions, the yellow aura color 26 may be allocated a different set of 10 questions, etcetera. Each question that related to the aura color red 24 may be assigned an answer weight number. Thus, questions that are directed to issues more closely on point with the true essence of an aura color 18 may be weighted more heavily, thus increasing the probability of identifying a correct aura color 18 to associate with a user 14. In at least one embodiment, one or more of the plurality of questions associated with an aura color 18 may be weighted greater than other questions for the same aura color 18. In at least one embodiment, the plurality of questions associated with an aura color 18 may each be weight differently.

Each answer weight associated with questions for an aura color 18 may be different by at least 10 percent from other answer weights for questions associated with that same aura color 18. In at least one embodiment, an answer weight associated with a most important question for an aura color 18 may be at least 90 percent greater than answer weight for a least important question associated with that same aura color 18. For example, and not by means of limitation, each question that relates to the aura color red 24 may be assigned an answer weight number between zero and eleven (1-10), with 10 being the highest weighting. Each of the 10 questions may be assigned an answer weight number that is only used once in connection with the single aura color. That is to say, each of the questions may have a different answer weight formed form a whole number (1-10) between zero and eleven. In at least one embodiment, each aura color 18 in the system 10 may include ten questions with each set of ten questions having different answer weights formed form a whole number (1-10) between zero and eleven. Each aura color 18 may have a different set of questions than the other aura colors. The question that is most associated with a personality trait most predominate with a particular aura color 18 is assigned an answer weight of 10, and a question with a least association with an aura color 18 is assigned an answer weight number of 1. For example, a red question of: “do people consider me to be self-sufficient, self-confident and influential?” is weighted the highest answer weighted question, such as an answer weight of 10, for the red aura color 18 because this characteristic is the most predominate attribute of an individual associated with a red aura color 24. A question such as “do I make people feel uncomfortable because of my honestly?” associated with a red aura color 24 may be weighted as a 7 because the question is testing a trait associated with a red aura color that is not as significant as the aura trait tested by the question having a largest answer weight of a 10.

If the aura color companion system 12 determined that a user 14 is associated with a yellow aura color 26, that user 14 may have entered the answer “yes” to more yellow aura color questions 26 than the user did so for red aura color questions. However, the user 14 could have possibly answered “yes” to more red aura color questions, but if the sum of answer weight numbers associated with the red aura color questions that the user answered “yes” to is less than the sum of answer weight numbers associated with the yellow aura color questions that the user answered “yes” to, then the user would be assigned a yellow aura color. That is to say, the user 14 could have possibly answered “yes” to questions associated with a yellow aura color 26 having more significance to a determination of whether the user 14 is associated with a yellow aura color 26 than answered “yes” to questions associated with a red aura color 24 having more significance to a determination of whether the user 14 is associated with the red aura color 24.

The answer weight numbers associated with the aura colors 18 of the aura color generator 16 may enable the aura color generator 16 to operate with a high degree of accuracy. When a user 14 selects “yes” to a question, the aura color generator 16 utilizes the designated answer weight numbers assigned to that question to determine a score associated with that question to which the user answered “yes”. The system 10 calculates the scores for a particular user 14 by summing the answer weight numbers assigned to questions to which the user answered “yes” to yield total answer weight numbers for each of the aura colors 18 for that particular user 14. The aura color 18 having the highest number is the first level aura color 34 associated with that user 14. For example, the aura color generator 16 of the system 10 could generate answer weight numbers for a user 14 as follows:

Red: 67

Orange: 75

Yellow: 45

Blue: 58

Green: 77

Violet: 49

In this example, the user must have answered “yes” to more significantly weighted questions associated with the green aura color 28 than other aura colors 18 or simply answered “yes” to more questions associated with the green aura color 28 than the user did for other aura color questions. The answer weight of each question enhances the accuracy of the aura color companion system 10.

The accuracy of the aura color companion system 10 may be further enhanced by creating matches with a user 14 beyond simply the first level aura color 34. In at least one embodiment, the aura color companion system 10 may be configured to identify a second level aura color 36, which may be used to identify matches for the user 14 at both the first level aura color 34 and the second level aura color 36. In particular, the system 10 may identify the aura color 18 having the second highest answer weight number as being the second level aura color 36. In the example above, the second level aura color 36 for the user is the orange aura color 30. The aura color companion system 10 may use both the first level aura color 34 and the second level aura color 36 to identify potential matches for the user 14. Thus, in the example above, a match for the user 14 at the second level aura color 36 would be a person having a red aura color 24 as the first level aura color 34 and an orange aura color 30 as the second level aura color 36. The aura color companion system 10 may list the potential matches and display them to the user 14 via a graphical user interface (GUI) or other appropriate way.

The accuracy of the aura color companion system 10 may be further enhanced by creating matches with a user 14 beyond simply the first and second level aura colors 34, 36. In at least one embodiment, the aura color companion system 10 may be configured to identify a third level aura color 38, which may be used to identify matches for the user 14 at the first level aura color 34, the second level aura color 36 and the third level aura color 38. In particular, the system 10 may identify the aura color 18 having the third highest answer weight number as being the third level aura color 38. In the example above, the third level aura color 38 for the user is the red aura color 24. The aura color companion system 10 may use the first level aura color 34, the second level aura color 36 and the third level aura color 38 to identify potential matches for the user 14. Thus, in the example above, a match for the user 14 at the third level aura color 38 would be a person having a red aura color 24 as the first level aura color 34, an orange aura color 30 as the second level aura color 36 and a green aura color 28 as the third level aura color 38. The aura color companion system 10 may list the potential matches and display them to the user 14 via a graphical user interface (GUI) or other appropriate way.

The accuracy of the aura color companion system 10 may be further enhanced by creating matches with a user 14 beyond simply the first, second and third level aura colors 34, 36, 38. In at least one embodiment, the aura color companion system 10 may be configured to identify a fourth level aura color 40, which may be used to identify matches for the user 14 at the first level aura color 34, the second level aura color 36, the third level aura color 38 and the fourth level aura color 40. In particular, the system 10 may identify the aura color 18 having the fourth highest answer weight number as being the fourth level aura color 40. In the example above, the fourth level aura color 40 for the user 14 is the blue aura color 22. The aura color companion system 10 may use the first level aura color 34, the second level aura color 36, the third level aura color 38 and the fourth level aura color 40 to identify potential matches for the user 14. Thus, in the example above, a match for the user 14 at the fourth level aura color 40 would be a person having a red aura color 24 as the first level aura color 34, an orange aura color 30 as the second level aura color 36, a green aura color 28 as the third level aura color 38 and a violet aura color 20 as the fourth level aura color 40. The aura color companion system 10 may list the potential matches and display them to the user 14 via a graphical user interface (GUI) or other appropriate way.

The aura color companion system 10 is not limited to only four levels of aura color matching. In other embodiments, the aura color companion system 10 may include five or six levels of aura color matching. The fifth and sixth levels of aura color matching may be carried out as set for above for levels one through four. In yet other embodiments, such as embodiments with more than six aura color options, the aura color companion system 10 may include additional number of levels of aura color matching greater than six.

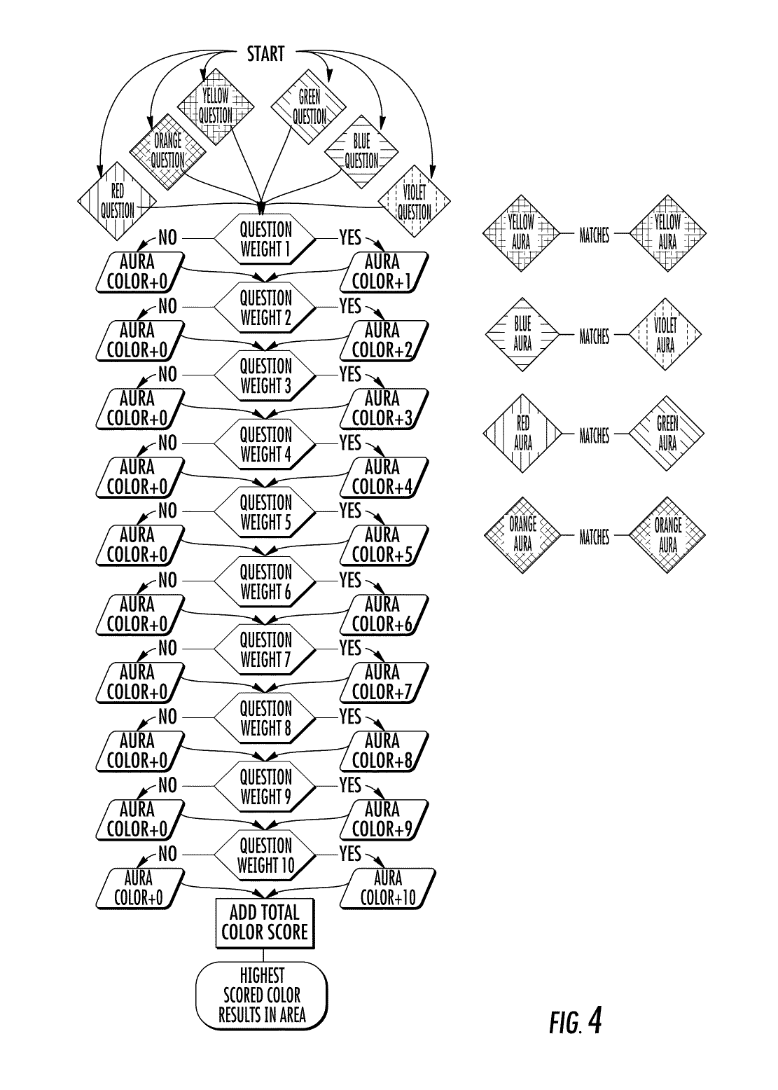

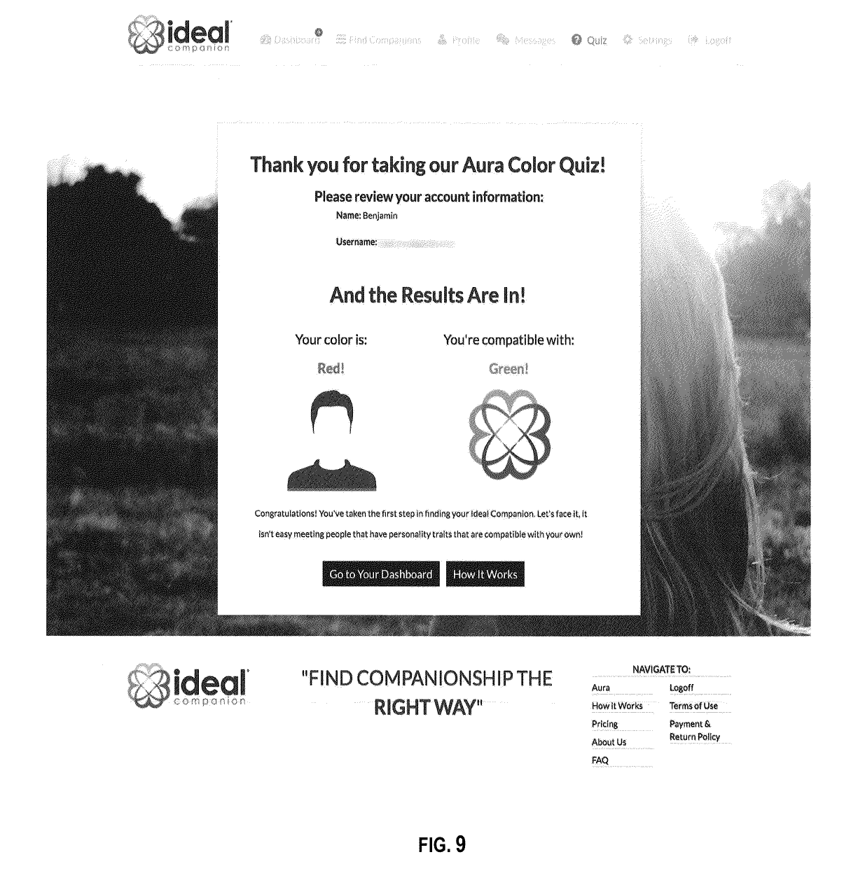

After a user 14 answers all questions posed from the aura color generator 16, thereby completing a personality test and receiving an association of at least a first level aura color 34 with the that user 14, the aura color companion system 10 may notify the user 14 of the association of the user with a first level aura color 34. The aura color companion system 10 may notify the user 14 via a GUI, as a communication, such as, but not limited to, email or other communication method, as shown in FIGS. 3 and 9, and other appropriate ways. In at least one embodiment, the aura color companion system 10 may notify the user 14 with a message such as:
“Congratulations! You have taken the first step in finding your companion. Let's face it. It isn't easy meeting people that have personality traits that are compatible with your own!”

As shown in FIG. 9, the aura color companion system 10 not only determines a user's aura color, but the aura color companion system 10 may also depict the aura color 18 that is associated with the user 14. In one example, a user 14 may be associated with a yellow aura color 26. A person who is associated with a yellow aura color 26 may be compatible with other users who are associated with a yellow aura color 26. In most cases, individuals having the same aura colors 18 are not compatible, however, individuals having yellow aura colors 26 are creative type people and are compatible. For example, rock stars often date rock stars. Further, a yellow aura color 26 may be defined as “individuals with a predominate personality color of yellow are positive, optimistic and easy going. In addition, people associated with a yellow aura color are very creative, entertaining and enjoy making people laugh. People associated with a yellow aura color are very compatible with other people associated with a yellow aura color.”

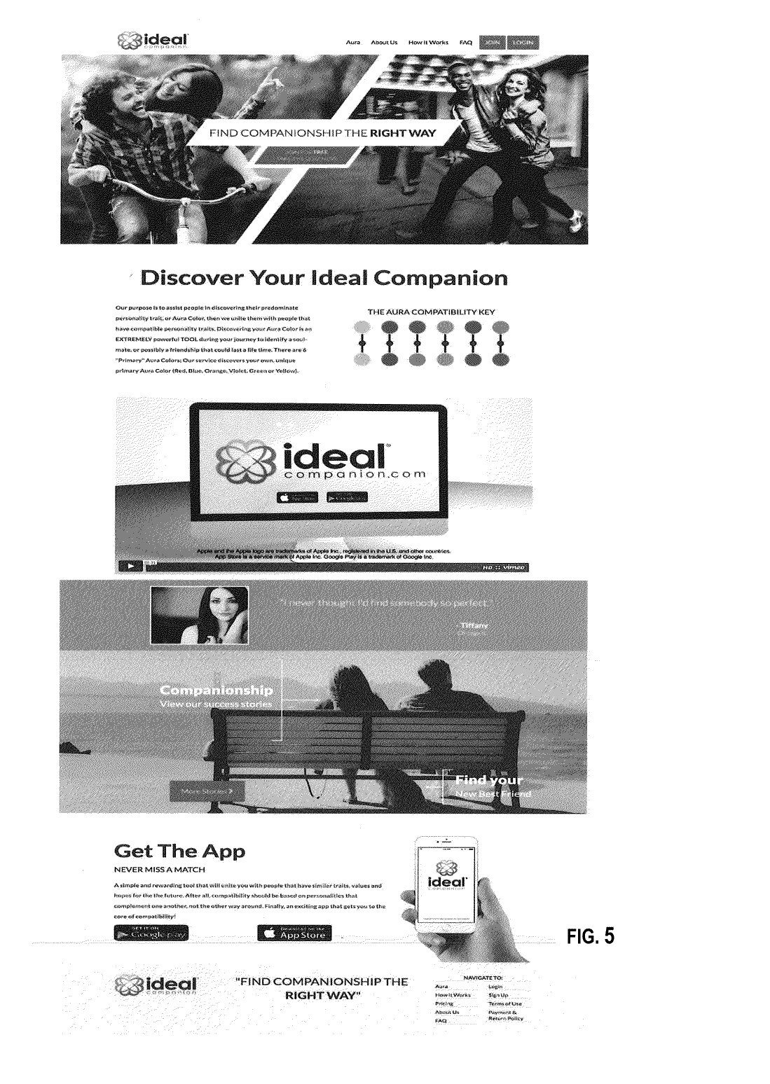

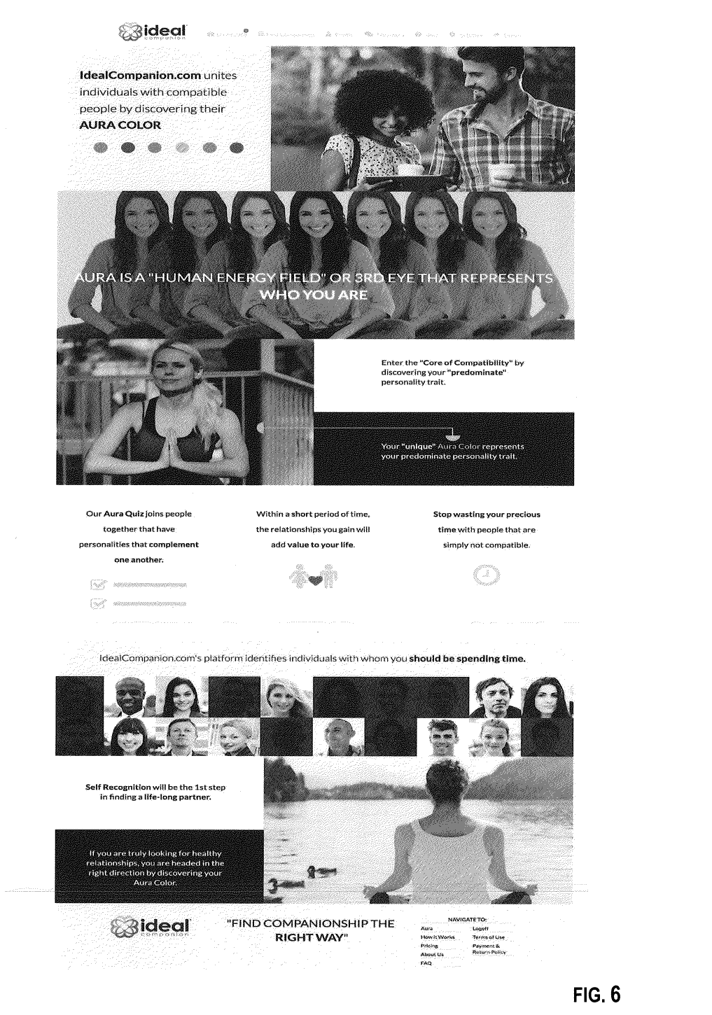

Once a user 14 receives a communication, such as an email, a link is provided to the user 14 that directs the user 14 to locate a companion. In at least one embodiment, the link may state “find people you are compatible with on Ideal Companion today!” The link may redirect the user to a registration page, as shown in FIGS. 5 and 6. Once registered, the user 14 can run compatibility searches wherever convenient to the user 14.

In at least one embodiment, the aura color companion system 10 may be configured to enable a user 14 to search the system 10 based upon one or more criteria at the user's discretion. For instance, a user 14 may search the aura color companion system 10 base upon one or more of the following criteria, which are provided by way of example, and not limitation: age, gender, sexual orientation, body type, hair color, eye color, ethnicity, height, children, smoker, drinker, education, religion, political views, desired type of relationship and distance away from person seeking match. The search feature of the aura color companion system 10 may be used by a user 14 to further limit match results generated by the aura color companion system 10 for a user 14. By further limiting the search results, the user 14 may increase the likelihood of finding a successful match.

In at least one embodiment, the aura color companion system 10 may be available to users via the internet or through other communication systems. Users of the aura color companion system 10 may be able to focus on the core of compatibility via use of the aura color generator 16. The aura color companion system 10 assists people in finding companions for romantic relationships with increased odds of having healthy relationships.

In some embodiments, the machine usable to enable a user 14 to access the aura color companion system 10 and to enable the aura color companion system 10 to operate may be a standalone device. In some embodiments, the machine may be connected to and assist with operations performed by other machines and systems, such as, but not limited to, the first user device 102, the second user device 104, a hardware element 106, a server 108, a database 110, internet/communications network 114 or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

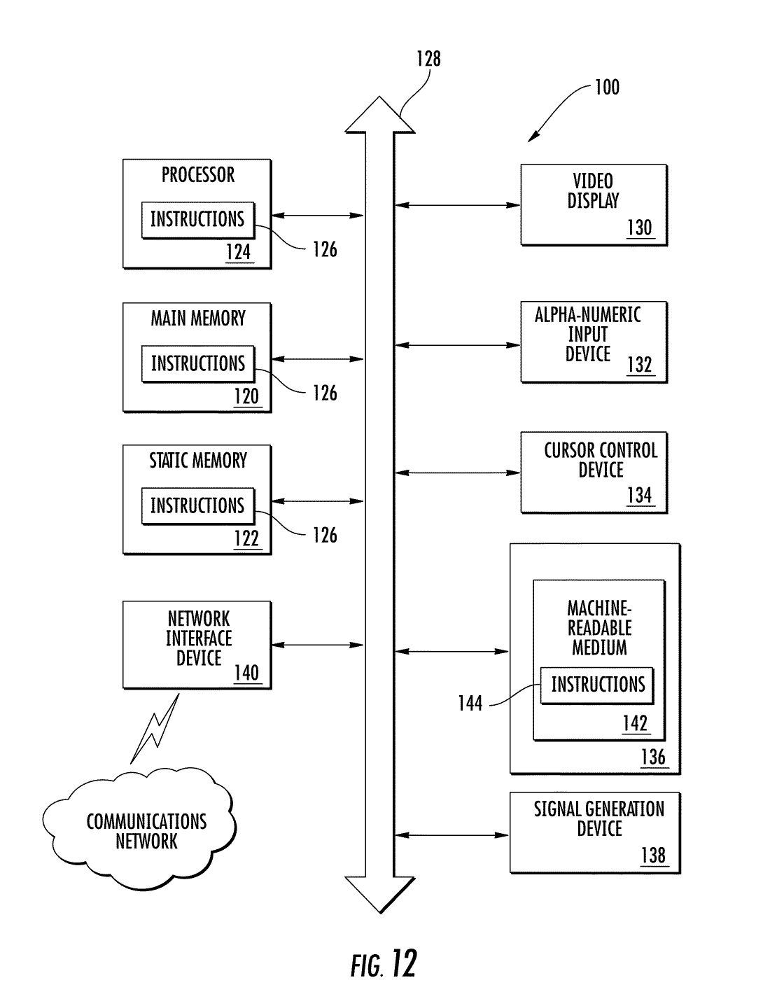

In at least one embodiment, a first user device 102 and a second user device 104 may be computers, servers, mobile devices, smartphones, computer tablets, phablets, or any other computing devices. Illustratively, the first user device 102 is shown as a smartphone in FIG. 11. In one embodiment, the first user device 102 may include a memory 103 that includes instructions, and a processor 105 that executes the instructions from the memory 103 to perform various operations that are performed by the first user device 102. The processor 105 may be hardware, software, or a combination thereof. Additionally, the first user device 102 may include a camera 107, which may be utilized to capture video, image, or other content. Furthermore, the first user device 102 may also include a global positioning sensor 106 that may be configured to provide location information for the first user device 102 and location information for the first user 14 that is using the first user device 102. The second user device 104 may include a memory 112 that includes instructions, and a processor 113 that executes the instructions from the memory 112 to perform various operations that are performed by the second user device 111. The processor 113 may be hardware, software, or a combination thereof. Illustratively, second user device 111 is shown as a mobile device in FIG. 11.

The first user 14 and the second user 14 may utilize the first user device 102 and second user device 104, respectively, to participate in communications sessions with each other. Additionally, the first user 14 and the second user 14 may utilize the first user device 102 and the second user device 104 to access and obtain various types of content and services, such as, but not limited to, audio content, video content, web content, text content, any type of content, or any combination thereof. Furthermore, the first and second users 14 may utilize the first and second user devices 102, 104 to perform a variety of other tasks and functions. In certain embodiments, the first user device 102 and second user device 104 may include software applications that may include a cloud-based application, gaming application, an internet-based application, a browser application, a mobile application, a productivity application, a video application, a music application, a streaming media application, a social media application, any other type of application, or a combination thereof. In certain embodiments, the software applications may include one or more graphical user interfaces (GUIs) for the first and second users 14 so as to enable the first and second users 14 to readily interact with the software applications. In certain embodiments, at least a portion of the software application may be configured to execute directly on the first user device 102 and second user device 104; however, in other embodiments, the software application may be configured to execute on the other devices and components in the system 100.

In at least one embodiment, the system 10 may include a memory 100 that stores instructions 102 and a processor 104 that executes the instructions 102 to perform operations. The system 10 may be configured to carry out a method 50, as shown in FIG. 13, of assisting formation of a personal relationship. The method 50 may include receiving answers from a person 14 at 52 to questions pertaining to that person 14 to determine aura color associations with that person 14. The method 50 may include generating at 54 an aura color 18 for the person 14 by adding answer weights corresponding to each yes answer by that person 14 for each aura color 18, ranking each aura color 18 at 58 for that person 14 with the largest number associated with an aura color 18 ranking first and a smallest number associated with an aura color 18 ranking last and identifying the aura color 18 at 60 ranking first as a first level aura color 34 for that person 14. The method 50 may also include generating at 62 one or more matches corresponding with the first level aura color 34 for that person 14.

The method 50 may also be configured such that the step of generating at least one match at 62 corresponding with the first level aura color 34 for that person 14 further includes generating a list of matches corresponding with the first level aura color 34. The list of matches may be presented to the user 14 via a GUI, as a communication, such as, but not limited to, email or other communication method, as shown in FIGS. 3 and 9, and other appropriate ways. The method 50 may also be configured such that the step of generating at least one match at 62 corresponding with the first level aura color 34 for that person 14 further includes generating a list of all matches according to the following aura color matching scheme: yellow with yellow, orange with orange, blue with violet, red with green, violet with blue and green with red.

The method 50 may also include identifying at 64 a second level aura color match via identifying an aura color 18 ranking second as a second level aura color 36 for that person 14 and generating at least one match, if any exist in the system 10, corresponding with the first level aura color 34 for that person 14 and corresponding with the second level aura color 36. The method 50 may also include identifying at 66 a third level aura color match via identifying an aura color 18 ranking third as a third level aura color 38 for that person 14 and generating at least one match, if any exist in the system 10, corresponding with the first level aura color 34 for that person 14, corresponding with the second level aura color 36 and corresponding with the third level aura color 38. The method 50 may also include identifying at 68 a fourth level aura color match via identifying an aura color 18 ranking fourth as a fourth level aura color 40 for that person 14 and generating at least one match, if any exist in the system 10, corresponding with the first level aura color 34 for that person 14, corresponding with the second level aura color 36, corresponding with the third level aura color 38 and corresponding with the fourth level aura color 40.

The step at 52 of receiving answers from a person 14 to questions pertaining to that person 14 to determine aura color 18 associations with that person 14 may also include receiving at least one answer to a plurality of questions provided to the person 14, whereby the questions include a plurality of questions associated with each aura color 18 within the system 10. The step at 52 of receiving at least one answer to a plurality of questions provided to the person 14 may also include receiving at least one answer to a plurality of questions provided to the person 14, whereby the questions include a plurality of questions associated with each aura color 18 within the system 10 including, yellow, orange, blue, violet, red and green. The step at 52 of receiving answers from a person 14 to questions pertaining to that person 14 to determine aura color 18 associations with that person 14 may also include receiving answers from the person 14 to questions associated with each aura color 18 have a corresponding answer weight signifying relative strength of the question and answer to a determination of an aura color 18 with the person 14 answering the questions, and wherein at least one of the questions for an aura color 18 has a greater answer weight than other questions. The step at 52 of receiving answers from a person 14 to questions pertaining to that person 14 to determine aura color 18 associations with that person 14 may also include receiving answers from the person 14 to questions associated with each aura color 18 have a corresponding answer weight signifying relative strength of the question and answer to a determination of an aura color 18 with the person 14 answering the questions and wherein each answer weight associated with questions for at least one aura color 18 are different by at least 10 percent from other answer weights for questions associated with that same aura color 18. The step at 52 of receiving answers from a person 14 to questions pertaining to that person 14 to determine aura color 18 associations with that person 14 may also include receiving answers from the person 14 to questions associated with each aura color 18 have a corresponding answer weight signifying relative strength of the question and answer to a determination of an aura color 18 with the person 14 answering the questions, and wherein an answer weight associated with a most important question for at least one aura color 18 is at least 90 percent greater than answer weight for a least important question associated with that same aura color 18.

The method 50 may also include searching at 70 the at least one match corresponding with the first level aura color 34 for that person 14 based upon one or more search criteria. Thus, the step at 70 enables a user 14 to narrow down the search results. For instance, if the search result were to return too many search results, such as, but no limited to, tens of thousands of search results, the search criteria can further limit down the search results. The step of search at 70 the at least one match corresponding with the first level aura color 34 for that person 14 based upon one or more search criteria may include searching the at least one match corresponding with the first level aura color 34 for that person based upon at least one search criteria being at least one personal attribute. The personal attributes may include, but are not limited to being, age, gender, sexual orientation, body type, hair color, eye color, ethnicity, height, children, smoker, drinker, education, religion, political views, desired type of relationship and distance away from person seeking match.

The method 50 may also include a step at 72 of storing aura color match levels 34, 36, 38, 40 for each person 14 having an account with the system 10. The step of step at 72 of storing aura color match levels 34, 36, 38, 40 for each person 14 having an account with the system 10 may include storing one or more personal attributes corresponding with each person and submitted by each person to the system 10.

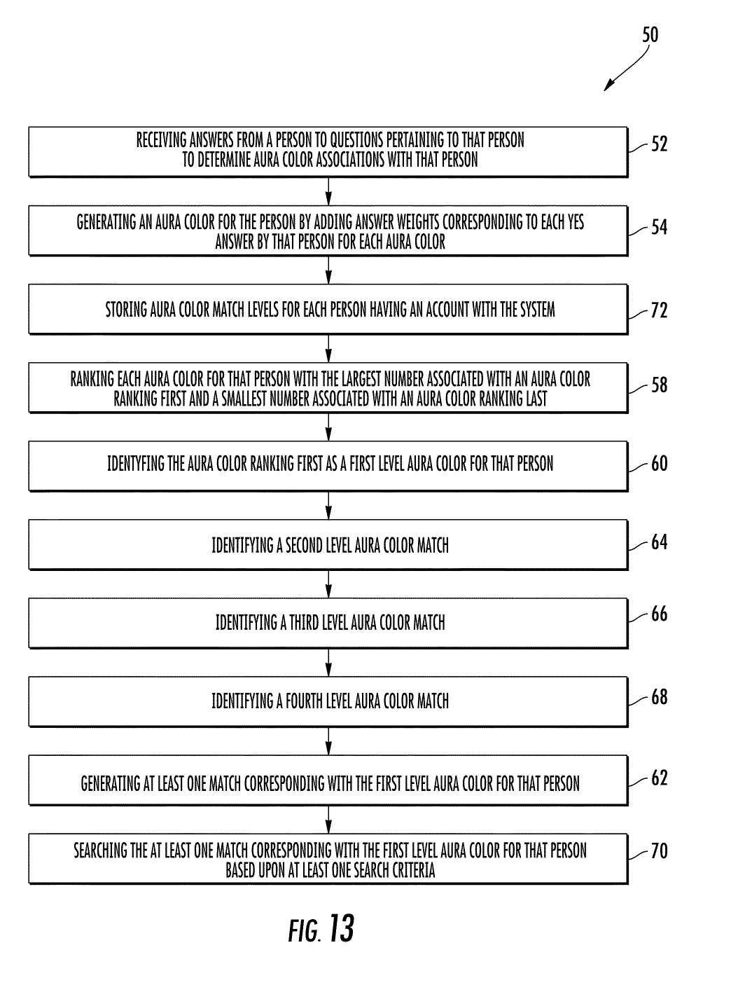

As shown in FIG. 12, at least a portion of the methodologies and techniques described with respect to the exemplary embodiments of the system 10 can incorporate a machine, such as, but not limited to, computer system 100, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10.

In some embodiments, the machine may operate as a standalone device. In some embodiments, the machine may be connected to and assist with operations performed by other machines and systems, such as, but not limited to, a first user device 102, a second user device 104, hardware element 106, server 108, or any combination thereof. The machine may be connected with any component in the system 10. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 100 may include a processor 124 (e.g., a central processing unit (CPU), a graphics processing unit (GPU, or both), a main memory 120 and a static memory 122, which communicate with each other via a bus 128. The computer system 100 may further include a video display unit 130, which may be, but is not limited to, a liquid crystal display (LCD), a flat panel, a solid state display, or a cathode ray tube (CRT). The computer system 100 may include an input device 132, such as, but not limited to, a keyboard, a cursor control device 134, such as, but not limited to, a mouse, a disk drive unit 136, a signal generation device 138, such as, but not limited to, a speaker or remote control, and a network interface device 140. The disk drive unit 136 may include a machine-readable medium 142 on which is stored one or more sets of instructions 144, such as, but not limited to, software embodying any one or more of the methodologies or functions described herein, including those methods illustrated above. The instructions 144 may also reside, completely or at least partially, within the main memory 120, the static memory 122, or within the processor 124, or a combination thereof, during execution thereof by the computer system 100. The main memory 120 and the processor 124 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the machine-readable medium 142 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device, or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

In at least one embodiment, a computer-readable device 100 may include instructions, which when executed by a processor 124, cause the processor 124 to perform operations including receiving answers from a person 14 at 52 to questions pertaining to that person 14 to determine aura color associations with that person 14. The computer-readable device 100 may include the instruction of generating at 54 an aura color 18 for the person 14 by adding answer weights corresponding to each yes answer by that person 14 for each aura color 18, ranking each aura color 18 at 58 for that person 14 with the largest number associated with an aura color 18 ranking first and a smallest number associated with an aura color 18 ranking last and identifying the aura color 18 at 60 ranking first as a first level aura color 34 for that person 14. The computer-readable device 100 may include the instruction of generating at 62 one or more matches corresponding with the first level aura color 34 for that person 14. The computer-readable device 100 may include instructions other than those listed herein, such as all steps described above in connection with the method 50 above and steps that make capabilities of the system 10 described above usable.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A system, comprising:
a memory that stores instructions; and
a processor that executes the instructions to perform operations, the operations comprising:
receiving answers from a person to questions pertaining to that person to determine aura color associations with that person;
generating an aura color for the person by adding answer weights corresponding to each yes answer by that person for each aura color, ranking each aura color for that person with the largest number associated with an aura color ranking first and a smallest number associated with an aura color ranking last and identifying the aura color ranking first as a first level aura color for that person; and
generating at least one match corresponding with the first level aura color for that person.

2. The system of claim 1, wherein the operation of generating at least one match corresponding with the first level aura color for that person further comprises generating a list of matches corresponding with the first level aura color.

3. The system of claim 1, wherein the operation of generating at least one match corresponding with the first level aura color for that person comprises generating a list of all matches according to the following aura color matching scheme: yellow with yellow, orange with orange, blue with violet, red with green, violet with blue and green with red.

4. The system of claim 1, further comprising the operation of:
identifying a second level aura color match via:
identifying an aura color ranking second as a second level aura color for that person; and
generating at least one match, if any exist in the system, corresponding with the first level aura color for that person and corresponding with the second level aura color.

5. The system of claim 4, further comprising the operation of:
identifying a third level aura color match via:
identifying an aura color ranking third as a third level aura color for that person; and
generating at least one match, if any exist in the system, corresponding with the first level aura color for that person, corresponding with the second level aura color and corresponding with the third level aura color.

6. The system of claim 5, further comprising the operation of:
identifying a fourth level aura color match via:
identifying an aura color ranking fourth as a fourth level aura color for that person; and
generating at least one match, if any exist in the system, corresponding with the first level aura color for that person, corresponding with the second level aura color, corresponding with the third level aura color and corresponding with the fourth level aura color.

7. The system of claim 1, wherein the operation of receiving answers from a person to questions pertaining to that person to determine aura color associations with that person further comprises receiving at least one answer to a plurality of questions provided to the person, whereby the questions include a plurality of questions associated with each aura color within the system.

8. The system of claim 7, wherein the operation of receiving at least one answer to a plurality of questions provided to the person further includes receiving at least one answer to a plurality of questions provided to the person, whereby the questions include a plurality of questions associated with each aura color within the system including, yellow, orange, blue, violet, red and green.

9. The system of claim 7, wherein the operation of receiving answers from a person to questions pertaining to that person to determine aura color associations with that person further comprises receiving answers from the person to questions associated with each aura color have a corresponding answer weight signifying relative strength of the question and answer to a determination of an aura color with the person answering the questions, and wherein at least one of the questions for an aura color has a greater answer weight than other questions.

10. The system of claim 7, wherein the operation of receiving answers from a person to questions pertaining to that person to determine aura color associations with that person further comprises receiving answers from the person to questions associated with each aura color have a corresponding answer weight signifying relative strength of the question and answer to a determination of an aura color with the person answering the questions, and wherein each answer weight associated with questions for at least one aura color are different by at least 10 percent from other answer weights for questions associated with that same aura color.

11. The system of claim 10, wherein the operation of receiving answers from a person to questions pertaining to that person to determine aura color associations with that person further comprises receiving answers from the person to questions associated with each aura color have a corresponding answer weight signifying relative strength of the question and answer to a determination of an aura color with the person answering the questions, and wherein an answer weight associated with a most important question for at least one aura color is at least 90 percent greater than answer weight for a least important question associated with that same aura color.

12. The system of claim 1, further comprising the operation of searching the at least one match corresponding with the first level aura color for that person based upon at least one search criteria.

13. The system of claim 12, wherein the operation of searching the at least one match corresponding with the first level aura color for that person based upon at least one search criteria further comprising searching the at least one match corresponding with the first level aura color for that person based upon at least one search criteria being at least one personal attribute.

14. The system of claim 1, further comprising the operation of storing aura color match levels for each person having an account with the system.

15. The system of claim 14, wherein the operation of storing aura color match levels for each person having an account with the system further comprises storing at least one personal attribute corresponding with each person and submitted by each person to the system.

16. A method of assisting formation of personal relationships, comprising:
receiving answers from a person to questions pertaining to that person to determine aura color associations with that person;
generating an aura color for the person by adding answer weights corresponding to each yes answer by that person for each aura color, ranking each aura color for that person with the largest number associated with an aura color ranking first and a smallest number associated with an aura color ranking last and identifying the aura color ranking first as a first level aura color for that person; and
generating at least one match corresponding with the first level aura color for that person.

17. The method of claim 16, further comprising:
identifying a second level aura color match via:
identifying an aura color ranking second as a second level aura color for that person; and
generating at least one match, if any exist in the system, corresponding with the first level aura color for that person and corresponding with the second level aura color;
identifying a third level aura color match via:
identifying an aura color ranking third as a third level aura color for that person; and
generating at least one match, if any exist in the system, corresponding with the first level aura color for that person, corresponding with the second level aura color and corresponding with the third level aura color; and
identifying a fourth level aura color match via:
identifying an aura color ranking fourth as a fourth level aura color for that person; and
generating at least one match, if any exist in the system, corresponding with the first level aura color for that person, corresponding with the second level aura color, corresponding with the third level aura color and corresponding with the fourth level aura color.

18. The method of claim 16, wherein receiving answers from a person to questions pertaining to that person to determine aura color associations with that person further comprises receiving at least one answer to a plurality of questions provided to the person, whereby the questions include a plurality of questions associated with each aura color within the system and further comprising receiving answers from the person to questions associated with each aura color have a corresponding answer weight signifying relative strength of the question and answer to a determination of an aura color with the person answering the questions, and wherein at least one of the questions for an aura color has a greater answer weight than other questions.

19. The method of claim 16, further comprising searching the at least one match corresponding with the first level aura color for that person based upon at least one search criteria being at least one personal attribute.

20. A system, comprising:
a memory that stores instructions; and
a processor that executes the instructions to perform operations, the operations comprising:
receiving answers from a person to questions pertaining to that person to determine aura color associations with that person, wherein the questions include a plurality of questions associated with each aura color within the system, the questions associated with each aura color have a corresponding answer weight signifying relative strength of the question and answer to a determination of an aura color to associate with the person answering the questions and wherein at least one of the questions for an aura color has a greater answer weight than other questions for the same aura color;
generating an aura color for the person by adding answer weights corresponding to each yes answer by that person for each aura color, ranking each aura color for that person with the largest number associated with an aura color ranking first and a smallest number associated with an aura color ranking last and identifying the aura color ranking first as a first level aura color for that person;
generating at least one match corresponding with the first level aura color for that person;
identifying a second level aura color match via:
identifying an aura color ranking second as a second level aura color for that person; and
generating at least one match, if any exist in the system, corresponding with the first level aura color for that person and corresponding with the second level aura color.
